(19) United States
(12) Patent Application Publication
(10) Pub. No.: US 2008/0088487 A1
(43) Pub. Date: Apr. 17, 2008

(54) Hand Writing Input Method And Device For Portable Terminal

(75) Inventor: Dong Li, League City, TX (US)

Correspondence Address: DONG LI, 2558 COSTA MESA CIRCLE, LEAGUE CITY, TX, 77573, US

(73) Assignee: Dong Li, League City, TX (US)

(21) Appl. No.: 10/593,121

(22) PCT Filed: Mar. 18, 2005
(86) PCT No.: PCT/CN05/00338

§ 371 Date: Sep. 18, 2006

(30) Foreign Application Priority Data
Mar. 19, 2004 (CN) 200410029609.8

(51) Int. Cl. G06F 3/023

(52) U.S. Cl. 341/22

(57) ABSTRACT

The present invention provides a method and apparatus of handwriting text input on a portable terminal with a microprocessor, a screen, and a keypad area formed by at least one key, comprising of: Placing at least one sensing unit in the keypad area of the portable terminal to form a sensing surface; Writing, with a sensing object on the said sensing surface, at least partial information of a desired text, to form a trajectory of movement; Generating, via the said sensing unit, multidimensional coordinates data from the said trajectory of movement of the said sensing object on the said sensing surface; Generating, via the microprocessor of the portable terminal processing the said multidimensional coordinates data, at least one text candidate; Displaying at least one of the said at least one text candidate on the screen of the portable terminal; Selecting the said desired text from the said at least one text candidate by pressing at least one of the at least one key in the keypad area of the portable terminal; Displaying the said desired text on the screen of the portable terminal.

### FIELD OF THE INVENTION

The invention relates generally to the field of electronics technologies, and more particularly, to a method and apparatus for facilitating text input using finger writing, such as finger writing input on portable terminal.

### BACKGROUND OF THE INVENTION

Portable terminals have become popular communication tools for many users with the development of communication technologies. Portable terminals are evolving towards miniaturization, personalization, differentiation, and data-convergence. For example, more and more mobile handset (as one of the portable terminals) users are using mobile email, instant message (IM), and short message (SMS) applications. However, to input text on a mobile handset especially to input non-alphabetical text such as Chinese is a very difficult task. Furthermore, text input on mobile handset becomes slower and slower as mobile handset becomes smaller and smaller. Existing input methods could not meet the needs as new mobile applications, especially those wireless internet applications based on high-bandwidth GPRS networks, demand for more user input on devices. This deficiency of input technology becomes the bottleneck of wide adoption of wireless internet applications.

The most commonly seen input method on mobile handsets is to enter text by pressing alphanumeric keys. Users have to press alphanumeric keys of a standard telephone keypad to select and input text. As described in U.S. Pat. No. 5,952,942 and China Patent CN1154912, a user needs to press keys “9264” if he wants to input Chinese character [symbol] (pin-yin is “WANG”). The microprocessor inside a mobile handset filters out those Chinese characters whose corresponding key sequences retrieved from a database do not match “9264”, and lists the matching Chinese characters such as [symbol] (pin-yin is “WANG”), [symbol] (pin-yin is “YANG”), and [symbol] (pin-yin is “ZANG”). The user then has to select his desired Chinese character from the listed candidates. Most of the time, the user has to press up-down navigation keys many times until he finds the desired Chinese character. The many input and selection key presses make text input very slow and error prone, because if a user selected a wrong character, he has to delete it and redo the input procedure again, wasting much time.

Many users enter English letters using the basic “multi-tap” method. For example, to enter letter “F”, a user has to press key “3” several times until letter “F” is found. There have been several intelligent input methods being implemented in mobile handsets to reduce the number of key presses required, such as the predictive input technology from Zi Corporation, the T9 input method from Tegic, and the iTAP input method from Motorola. These methods use software algorithms to predict likely letter combinations from input key sequence. However, there could be many letter combinations for a input key sequence and a user shall still have to press up-down navigation keys to select his desired text.

Handwriting recognition has also been implemented in mobile handset to enter text. Such a device requires a high-resolution touch-screen, a special IC, and a handwriting recognition algorithm. There are two types of commonly used handwriting pads: resistive and capacitive. A resistive handwriting pad comprises a flexible resistive thin-film and a rigid resistive thin-film with air in the middle to separate these two layers. Its working principle is the following: when a stylus or finger applying force to the handwriting pads, the top resistive layer bends to the pressure and makes contacts with the bottom resistive layer, and hence closing an electronic circuit indicating the position of the stylus or finger. A capacitive handwriting pad works similarly, but uses change in capacitance from the pressure applied from the stylus against the handwriting pad to determine the position of the stylus. User needs to use stylus against touch-screen to input text into portable terminals.

Generally, a touch-screen is divided into several functional areas, such as text input writing area, menu/icon area, and candidate text display area. When a user writes strokes of his desired text on the touch-screen using a stylus, the IC controller in the portable terminal senses the pressure changes of the moving stylus on the touch-screen. The XY coordinates data of the written stroke is recorded and sent to handwriting recognition processor. Then candidate text closely matching the written strokes will be displayed on screen. User can select and confirm or delete any of the candidate text displayed with the stylus touching the menu/icon area of the touch-screen. There are several input modes, such as Chinese character mode, letter mode, and digit mode, which are represented by specific icons. User can tap icon to select input mode, which helps to achieve high recognition rate. A virtual keyboard can be displayed on the touch-screen as well; user can just tap virtual keys to input text. In summary, the entire input method and system is based on applying a stylus on a touch-screen to enter text.

One drawback of such method and apparatus is that the display area is divided into several functional areas, such as text input writing area, menu/icon area, and candidate text display area. Another drawback of entering text in mobile handset using this method is that it requires highly sophisticated recognition algorithm and large memory in order to achieve high recognition rate. These requirements increase the cost of mobile handset dramatically. When display size is limited by the size of the portable terminal itself, the competition between text input writing area and candidate text display area of a size limited touch-screen makes the functionality of mobile handset restricted. To keep the overall size small, most of the touch-screen mobile handset designs have one touch-screen alone but no keypad. User has to use the virtual keypad on the touch-screen to dial phone number, which is generally acknowledged as very inconvenient. There are some mobile handsets having both touch-screen and keypad, however, making them big in size and difficult to carry.

Recently, touchpad similar to the one used in notebook computer has been implemented in mobile handset. For example, there is a touchpad inside the flip of Nokia 6108 handset. When the flip is closed, user can press keys on the keypad to dial phone numbers. And when opening the flip, there is a touchpad. User can use stylus to enter text on the touchpad. There are several functional areas on the touchpad: text input area, input mode change area, and menu/icon area. User uses stylus to write text strokes or stroke combinations on the touchpad. The IC controller in the mobile handset senses the pressure changes of the moving stylus on the touchpad. The XY coordinates data of the strokes is recorded and sent to handwriting recognition processor. Then those candidate text closely matching the written strokes will be displayed. User can select and confirm or delete those candidate text displayed using the stylus touching the menu/icon area of the touchpad. There are several input modes, Chinese character mode, letter mode, and digit mode, which are represented by specific icons. User can tap on a corresponding icon to select a input mode in order to achieve higher recognition rate. In such a setting, the input-writing area is different from the screen display area, allowing better utilization of the screen display area and the input-writing area. However, having physically separated touchpad and keypad increases the cost and size of the mobile handset.

### SUMMARY OF THE INVENTION

In order to overcome the above-described problems, an object of the present invention is to provide a method and system of handwriting text input on a portable terminal, which provides this new text input function while keeping the original physical size of the mobile handset and original functionality of the digit keypad of the mobile handset intact.

The present invention teaches a method of handwriting text input on a portable terminal with a microprocessor, a screen, and a keypad area formed by at least one key, comprising of: Placing at least one sensing unit in the keypad area of the portable terminal to form a sensing surface; Writing, with a sensing object on the said sensing surface, at least partial information of a desired text, to form a trajectory of movement; Generating, via the said sensing unit, multidimensional coordinates data from the said trajectory of movement of the said sensing object on the said sensing surface; Generating, via the microprocessor of the portable terminal processing the said multidimensional coordinates data, at least one text candidate; Displaying at least one of the said at least one text candidate on the screen of the portable terminal; Selecting the said desired text from the said at least one text candidate by pressing at least one of the at least one key in the keypad area of the portable terminal; Displaying the said desired text on the screen of the portable terminal.

The said partial information of the said desired text can be any of a stroke, a component, a partial character, a character, a word, a sentence, or their combination.

The said partial information written with the said sensing object on the said sensing surface can be stroke or stroke combination of the said desired text, the said at least one text candidate generated from the said processing of the said multidimensional coordinates data and displayed on the screen of the portable terminal can include text component such as radical, letter and affix, further comprises the steps of: Selecting a text component from the said at least one text candidate by pressing at least one of the at least one key in the keypad area of the portable terminal; Generating, via the microprocessor of the portable terminal, at least one associated text candidate corresponding to the said selected text component; Displaying at least one of the at least one associated text candidate on the screen of the portable terminal, in place of the previous said at least one text candidate; If the desired text is not in display, the method could further comprise the steps of: Writing, with the said sensing object on the said sensing surface, at least one additional stroke or stroke combination of the desired text to form a new trajectory of movement, wherein the said additional stroke or stroke combination is not part of the said selected text component; Generating, via the said sensing unit, multidimensional coordinates data of the said at least one additional stroke or stroke combination of the desired text from the said trajectory of movement of the said sensing object on the said sensing surface; Generating, via the microprocessor of the said portable terminal processing the said multidimensional coordinates data and the said selected text component, at least one candidate text that may further include text component such as radical, letter and affix; Displaying at least one of the said at least one candidate text on the screen of the portable terminal. The above steps can be repetitively applied until the desired text is in display.

The said sensing unit can be capacitive, generating multi-dimensional coordinates data through measuring the capacitance or the change of capacitance of the sensing unit.

The said sensing unit can be resistive, generating multi-dimensional coordinates data through measuring the resistance or the change of resistance of the sensing unit.

The said sensing unit can be inductive, generating multi-dimensional coordinates data through measuring the inductance or the change of inductance of the sensing unit.

The said sensing unit is impedance-based, generating multi-dimensional coordinates data through measuring the impedance or the change of impedance of the sensing unit.

The said at least one key can be: push-down button, roller button, gliding wheel, rotational switch, optical sensing switch, or bridge-sensing switch.

The said at least one key is located on the outer surface of the portable terminal.

The said sensing unit is coupled with the said at least one key in the said keypad area of the portable terminal.

The said coupling of the said sensing unit and the said at least one key in the said keypad area of the portable terminal can be electronically combining and sharing electronic circuit of the said sensing unit and that of the said at least one key.

The said coupling of the said sensing unit and the at least one key in the said keypad area of the portable terminal can be mechanically combining and sharing the mechanical structure of the said sensing unit and that of a plurality of the said at least one key.

The said sensing object can be: human finger, input stylus or pen-shaped objects.

The screen of the portable terminal has a text editor display area and a candidate text display area, further comprises the steps of: Designating the most probable first candidate text as current text and displaying it in the text editor display area of the screen of the portable terminal; Generating at least one associated candidate text of the said current text, wherein the generation is from the microprocessor of the portable terminal processing the knowledge of the said current text, wherein the said knowledge is retrieved from a knowledge base; Displaying at least one associated candidate text in the candidate text display area of the screen of the portable terminal; Selecting one of the said associated candidate text by pressing at least one key of the said at least one key, wherein the said associated candidate text can be character, word phrase, sentence or their combination; Displaying the selected associated candidate text in the said text editor display area of the screen of the portable terminal.

The said pressing of at least one key or key combination can be pressing numeric key; wherein the said selection of the desired text from the said candidate text can be to select the candidate text associated with a sequence number the same as the number marked on the said pressed numeric key, and wherein the said displaying of the selected text can be to display it in the text editor display area of the screen of the portable terminal.

The selection of the desired text from the said candidate text by the said pressing of at least one key or key combination can be pressing at least one navigation functional key to move a cursor to a candidate text and pressing a confirm/select functional key to select this candidate text; and wherein the said displaying of the selected text can be to display it in the text editor display area of the screen of the portable terminal.

The said generation of at least one candidate text of the desired text further comprises the step of pressing at least one of the said at least one key to delete at least one candidate text.

The said generation of the at least one candidate text of the desired text, further comprises the step of pressing at least one of the said at least one key to change the order of the said at least one candidate text.

The said generation of the at least one candidate text of the desired text, further comprises the step of pressing at least one of the said at least one key to insert at least one candidate text.

The said sensing surface formed by printing the said sensing units on the surface area of the at least one key and the surface area between the said keys of the portable terminal.

The said sensing unit is a contact switch.

The said surface of the said at least one key can be the visible surface of the said key.

The said contact switch is made of electrically conductive material and is connected to at least on resistor; the said sensing area is formed by arranging a plurality of the said contact switches as a matrix on the surface area of the said at least one key and the surface area between the said keys; each of the said contact switch is numbered and taken as a data sampling point;

The said multi-dimensional coordinates data is generated by electronically coupling at least one of the said contact switches with a conductive sensing object electronically touching the said sensing surface; the said number of the at least one touched conduct switch is sent as coordinate data to the microprocessor of the portable terminal for processing; the said at least one key is triggered when the said conductive sensing object pressing the said key and causing electronic connection of the conductive switch; the microprocessor recognizes the pressed key and takes corresponding actions.

The said contact switch is printed on the keypad area in shapes suitable for sensing.

The said contact switch is printed on the keypad area in rectangular, circular, ovular, triangular, polygonal shape or other shapes suitable for sensing.

Contact switches of the same or different shapes are printed in the keypad area to form contact switch matrix.

Each sensing unit is a node of the said contact switch matrix.

Sensitivity of the sensing surface is dependent on the density of the said contact switch matrix.

The said sensing units are placed under the surface of the said at least one key and under the surface area between the said keys of the portable terminal, to form sensing surface.

The said sensing unit is made up of at least one contact switch made of electrically conductive materials, and each of the said contact switch is electronically connected to at least one resistor, at least one capacitance, and at least one diode to form a capacitive sensing component;

The said sensing surface is formed by at least one capacitive sensing unit placed as a matrix under the surface of the at least one key and the surface of the keypad area;

The said multidimensional coordinates data comes up when the said sensing object is placed on or near the said sensing surface in the keypad area to cause capacitive effects with the sensing units underneath, and when the said sensing object slides on the surface to form a trajectory of movement; the said multidimensional coordinates data is to be used by the microprocessor of the portable terminal for recognition process;

The said at least one key turns on when a finger-like object pushes the said key to cause a layer of conductive material inside the key to electronically connects the underneath contact switch; the microprocessor determines which key is pressed and carries corresponding functions.

The said portable terminal is a mobile handset.

The said keypad area can be the keypad area of a mobile handset.

The said desired text can be in alphabetical letters, Chinese characters, Japanese characters, and other hieroglyphs and symbols.

The present invention also teaches a portable terminal, which with a keypad area formed by at least one key, further comprising: A sensing surface, formed by at least one sensing unit placed in the keypad area of the portable terminal; A sensing object, for writing at least partial information of a desired text on the said sensing surface, generating multidimensional coordinates data from the trajectory of the movement of the said sensing object via the said sensing unit; A microprocessor, for processing the said multidimensional coordinates data and for generating at least one candidate text; A screen, for displaying the said at least one candidate text; The desired text can be selected from the said at least one candidate text by pressing the said at least one key, and be displayed on the said screen.

The important benefits of the present invention are: it does not need to increase the physical size of the portable terminal, or to change its physical shape while keeping original functionality of the digit keypad of the portable terminal intact. In addition, the input-writing area is different from the screen display area, allowing better utilization of the screen display area and the input-writing area.

### BRIEF DESCRIPTION OF THE DRAWINGS

FIG. 1 shows the block diagram of a portable terminal in a preferred embodiment of the invention;

FIG. 2 illustrates a preferred embodiment of the invention where a sensing surface formed by a matrix of contact switches 200 placed on the digit keypad 140 of a mobile handset;

FIG. 3 is a schematic diagram of a key whose surface is printed with contact switches in a preferred embodiment of the invention;

FIG. 4 shows two schematic diagrams of the contact switch in preferred embodiments of the invention;

FIG. 5 is a circuit schematic diagram of the sensing surface 150 and the trajectory of movement processor 160 of a preferred embodiment of the portable terminal in this invention;

FIG. 6 is the schematic diagram of the handwriting input of Chinese character [symbol] on the 9×7 contact switch matrix shown in FIG. 2 of a preferred embodiment of the invention;

FIG. 7 is the schematic diagram of the handwriting input of capital Roman letter “A” on the 9×7 contact switch matrix shown in FIG. 2 of a preferred embodiment of the invention;

FIG. 8 shows that the sensing surface can be formed by placing one or more capacitive sensing units under the digit keypad of the portable terminal;

FIG. 9 is the illustrative diagram of a keypad with a sensing surface formed by placing a capacitive sensing unit beneath;

FIG. 10 is a portion of a schematic diagram of a circuit design in a preferred embodiment of the portable terminal of the present invention;

FIG. 11 is the illustrative diagram of different display areas, keypad, and sensing surface of the mobile handset under hand writing text input mode;

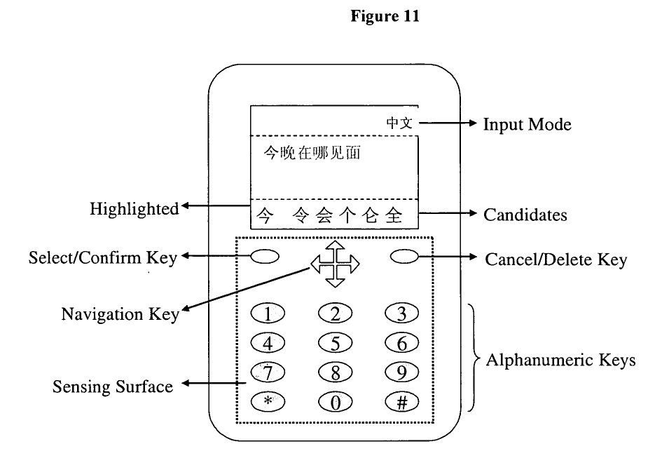

FIG. 12 is the flow chart of a text input procedure for entering text by writing the whole desired text;

FIG. 13 shows the flow chart of an input procedure for entering text by writing desired text incrementally stroke by stroke;

FIG. 14 shows the flow chart of an input procedure for entering text by writing desired text component by component.

### DESCRIPTION OF THE PREFERRED EMBODIMENTS

The preferred embodiments are described in details with drawings:

The present invention teaches a method of handwriting text input on a portable terminal with a microprocessor, a screen, and a keypad area formed by at least one key, comprising of:

Placing at least one sensing unit in the keypad area of the portable terminal to form a sensing surface; The said sensing unit can be coupled with the said at least one key in the said keypad area of the portable terminal; The electronic circuit of the said sensing unit and that of the said at least one key in the said keypad area of the portable terminal can be electronically combined and shared; The mechanical structure of the said sensing unit and that of the said at least one key in the said keypad area of the portable terminal can be mechanically combined and shared; The electronic circuit of the said sensing unit and that of the said at least one key in the said keypad area of the portable terminal can be coupled with the said microprocessor;

Writing, with a sensing object on the said sensing surface, at least partial information of a desired text, to form a trajectory of movement;

Generating, via the said sensing unit, multidimensional coordinates data from the said trajectory of movement of the said sensing object on the said sensing surface;

Generating, via the microprocessor of the portable terminal processing the said multidimensional coordinates data, at least one text candidate;

Displaying at least one of the said at least one text candidate on the screen of the portable terminal;

Selecting the said desired text from the said at least one text candidate by pressing at least one of the at least one key in the keypad area of the portable terminal;

Displaying the said desired text on the screen of the portable terminal.

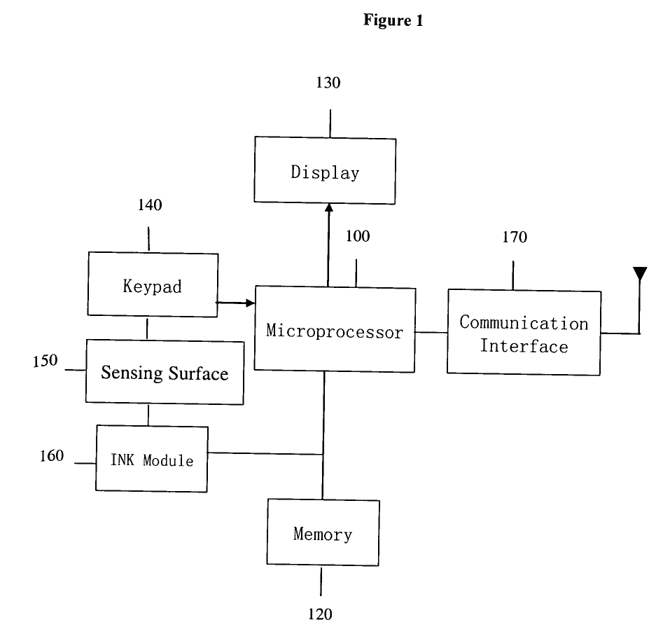

FIG. 1 shows the block diagram of a portable terminal in a preferred embodiment of the invention. The portable terminal comprises of a microprocessor (MCU) 100, a memory 120, a keypad 140, a sensing surface 150, and a processor of multidimensional coordinates data of a trajectory of movement (INK module) 160, a screen 130, and a communication interface 110.

The keypad 140 of the portable terminal can be a standard telephone keypad or any other small keypad that a user can use to input digits, letters and symbols, or Chinese characters. The screen 130 can be used to display text entered with finger or stylus. The communication interface 110 can be any apparatus with a receiver and a transmitter. User can communicate with other portable terminals via the communication interface 110 through, for example, wireless networks.

The portable terminal of the preferred embodiment works with the microprocessor 100 loads a handwriting recognition software, a handwriting recognition database and knowledge-base from memory 120, receives handwriting ink data (multidimensional coordinates data), and controls the overall operation of the portable terminal. The handwriting recognition software, handwriting recognition database and knowledge-base, handwriting ink data (multidimensional coordinates data) and other data needed for the operation of the microprocessor is stored in memory 120.

The operation procedure of the preferred embodiment is as follows. A user conducts handwriting input on the keypad 140 and the sensing surface 150. The processor 160 of trajectory of movement processes the analog signal generated from the trajectory of movement of the handwriting and converts it into digital multidimensional coordinates data. The microprocessor processes the digital multidimensional coordinates data for handwriting recognition. Processing parameters and corresponding matching data are retrieved from memory 120, and matching text candidates are displayed on the screen 130. The recognized input text can be sent to other portable terminals through the communication interface 110.

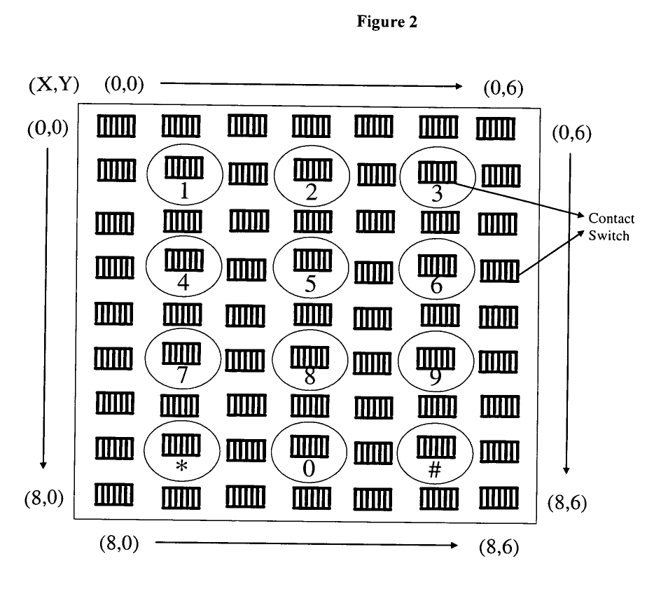

FIG. 2 illustrates a preferred embodiment of the invention where a sensing surface formed by a matrix of contact switches 200 placed on the digit keypad 140 of a mobile handset. These contact switches may be printed directly on the keys of the digit keypad, on the space between the keys, or even on the margin space of the keys. Electrically conductive materials, such as metal, are used for these contact switches. Each contact switch identified with a specific location coordinate. What shown in FIG. 2 is a 9×7 matrix arranged from the top-left (0, 0) to the bottom-right (6, 8). Every contact switch represents a sensing unit for data collection. When a human finger or a conductive stylus touches the keypad surface, it electrically connects to the contact switch being touched and completes the circuit of the sensing unit. After analog and/or digital conversion, The electronic signal from the sensing unit becomes the location coordinate data, which is stored in memory 120, to be used by the microprocessor 100 for recognition. No pressure measurement is needed for determining if a specific contact switch is touched, because the finger or stylus touching the contact switch electrically closed the circuit. More contact switches may be used to achieve higher resolution. For example, if every single contact switch in FIG. 2 is replaced by 4 contact switches, a 36×28 matrix is formed.

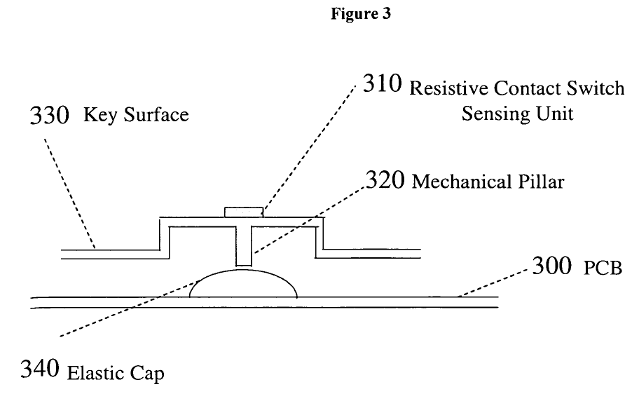

FIG. 3 is a schematic diagram of a key whose surface is printed with contact switches in a preferred embodiment of the invention. When a finger presses the key, it makes electronic contact with the contact switch and closes the electronic circuit of the contact switch with the electronically conductive human finger. After A/D conversion, the location coordinate data of the specific contact switch is stored in memory 120, to be used by the microprocessor 100 for recognition. The microprocessor 100 determines that the specific key has been touched and conducts corresponding functions. If the finger further presses downward on the specific key, it forces the mechanical pillar 320 beneath to move downwards. However, the elastic cap 340 right below the mechanical pillar 320 gives resistance to the downward movement of the finger. When the finger pressure is released from the key, the elastic cap 340 pushes the mechanical pillar 320 back to its original position. This mechanism enables tactile feedback and achieves the mechanical switch behavior commonly seen in a mobile handset.

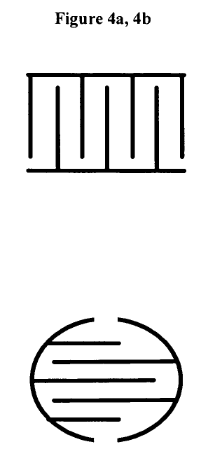

FIG. 4 shows two schematic diagrams of the contact switch in preferred embodiments of the invention. The illustrated switch patterns can be used in various ways. They have the preferred electrical property that, when a finger or a conductive stylus touches the surface of the contact switch matrix, the circuit can be more reliably closed. The contact switch can have other printing patterns with similar electrical properties. A contact switch matrix is formed when each contact switch is printed with the printing pattern as illustrated. In idle state, the two electrical wires are not in contact and hence the circuit is open.

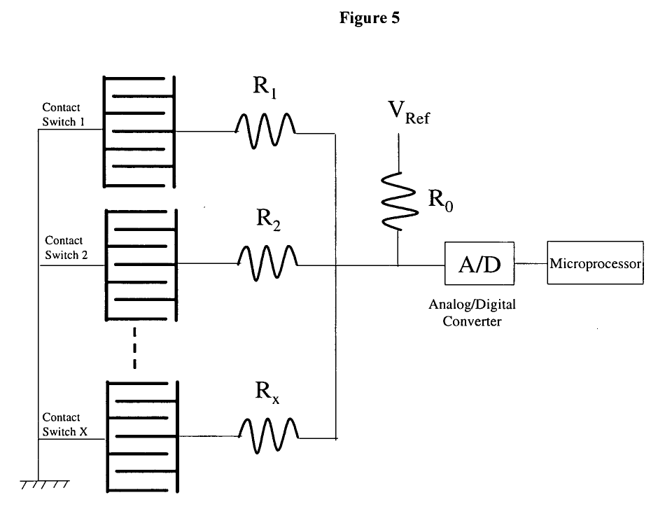

FIG. 5 is a circuit schematic diagram of the sensing surface 150 and the trajectory of movement processor 160 of a preferred embodiment of the portable terminal in this invention. The circuit comprises contact switches, resistors, A/D converters 210, and a microprocessor 100. Each contact switch is connected to a resistor 220 and is arranged to form a contact switch matrix. The resistor 220 connected to a contact switch is further connected to the A/D converter 210. The resistor 230 is linked to reference power source V_{Ref} and is further connected to the contact switch matrix and the A/D converter 210, with the latter further connected to the microprocessor 100. This A/D converter can be a multi-channel A/D converter. When a finger or a conductive stylus moves on the surface and keeps in contact with the contact switch matrix, the movement closes in sequence the electrical circuits of the contact switches being touched and generates electronic signal through the resistor 220. The signal, combined with the electronic current from the power source V_{ref}, becomes the input of the A/D converter 210. The signal is regulated and converted into digital signal 30 and is sent to the microprocessor 100. The A/D converter 210 and the microprocessor can be integrated as one unit. Both the A/D converter 210 and the microprocessor 100 are connected to the digit keypad circuit of the portable terminal. These components can be integrated into a single circuit.

Before start, it is to set input mode to handwriting recognition. Mode setting has been taught in prior art and will not be repeated here. When people writing with his finger or conductive stylus moving on the digit keypad and keeping in contact with the keypad surface, the electrical wires of the contact switches are connected that generates electronic signal. The electronic signal generated from the electrical contacts of one or more contact switches during writing is regulated and converted by the A/D converter 210 into a sequence of digital “0s” (“0” means connection on) and “1s” (“1” means connection off). The A/D converter then generates contact switch location coordinates (X, Y) of the contact switches that are electrically turned on during writing input. The microprocessor with handwriting recognition software processes the contact switch location coordinates data and generates a plurality of candidate text for the desired text of his writing and displays some of the candidate text on the screen of the portable terminal. The user can press key or key combinations to select and confirm his desired text among the candidate text. The text will be shown on the screen of the portable terminal.

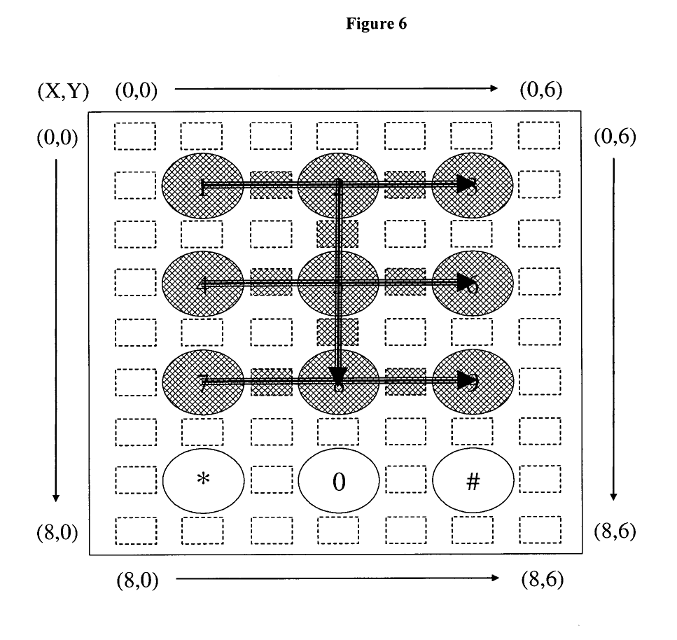

FIG. 6 is the schematic diagram of the handwriting input of Chinese character [symbol] on the 9×7 contact switch matrix shown in FIG. 2 of a preferred embodiment of the invention. When a user using his finger or a conductive stylus to draw strokes of the Chinese character by writing on the digit keypad and by making contacts with the surface of the keypad, the following contact switches identified by their location coordinates are electronically connected in sequence: the first stroke: (1, 1), (1, 2), (1, 3), (1, 4), (1, 5); the second stroke: (3, 1), (3, 2), (3, 3), (3, 4), (3, 5); the third stroke: (1, 3), (2, 3), (3, 3), (4, 3), (5, 3); and the forth stroke: (5, 1), (5, 2), (5, 3), (5, 4), (5, 5). The microprocessor with handwriting recognition software first processes the location coordinates data and stores some generated ink feature data to memory. Then it retrieves from the memory ink feature data for all the strokes, and generates several highly similar strokes. The microprocessor is then applied to generate best matching of complete Chinese characters as candidate text for the desired text, Chinese character [symbol] The microprocessor shall further processes the encodings of the matching candidate text and displays Chinese character [symbol] among others, on the screen of the portable terminal.

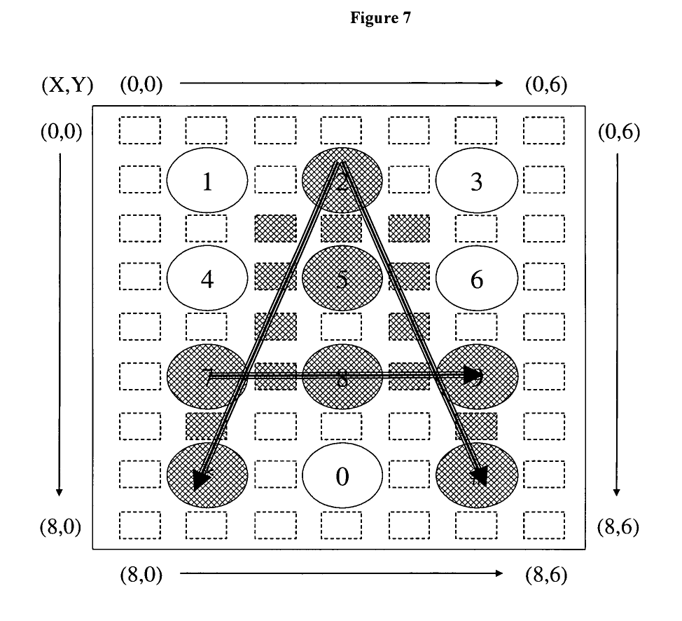

FIG. 7 is the schematic diagram of the handwriting input of capital Roman letter “A” on the 9×7 contact switch matrix shown in FIG. 2 of a preferred embodiment of the invention. When a user using his finger or a conductive stylus to draw strokes of the capital Roman letter by writing on the digit keypad and by making contacts with the surface of the keypad, the following contact switches identified by their location coordinates are electronically connected in sequence: the first stroke: (1, 3), (2, 2), (2, 3), (3, 3), (4, 2), (5, 1), (5, 2), (6, 1), (7, 1); the second stroke: (1, 3), (2, 3), (2, 4), (3, 3), (3, 4), (4, 4), (5, 4), (5, 5), (6, 5), (7, 5); and the third stroke: (5, 1), (5, 2), (5, 3), (5, 4), (5, 5). The microprocessor with handwriting recognition software processes the location coordinates data, and generates a list of candidate text that are most similar ones to the desired text, Roman character “A”, and display it, among others, on the screen of the portable terminal.

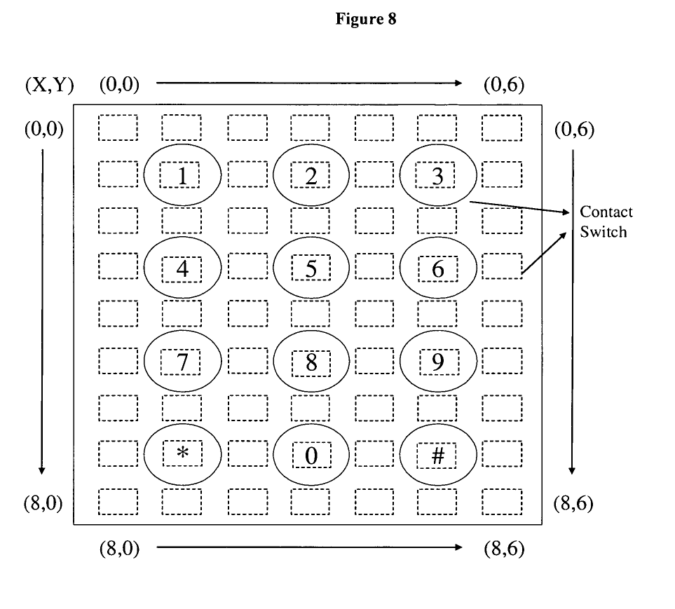

Another illustrative embodiment of the present invention is shown in the following figures. FIG. 8 shows that the sensing surface can be formed by placing one or more capacitive sensing units under the digit keypad of the portable terminal. These capacitive sensing units can be printed on the printed circuit board (PCB) directly under the digit keys, under the area between the digit keys, or under the margin space of the keypad. Each of the capacitive sensing units is assigned its own unique location coordinates. In FIG. 8, a 9×7 matrix is shown with sensing units assigned location coordinates from the top-left (0, 0) to the bottom-right (6, 8). When a conductive finger moves on the keypad area, the finger and the capacitive sensing unit beneath causes changes in impedance of the sensing unit, which enables the microprocessor 100 to identify and calculate multidimensional coordinates data (X, Y) of the finger. According to one aspect of the present invention, the finger does not necessarily need to touch the sensing unit physically. It only needs to be within the sensing range of the capacitive sensing unit.

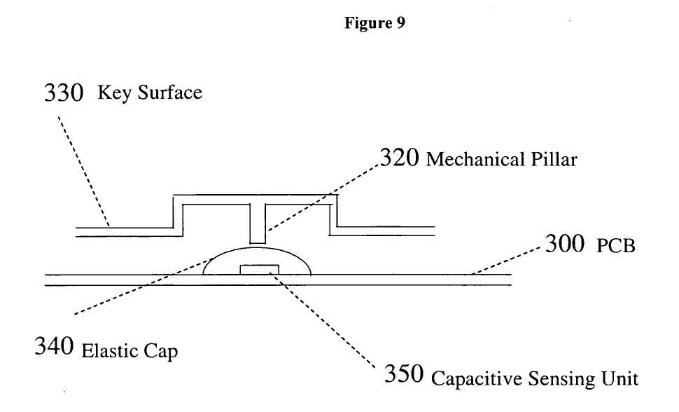

FIG. 9 is the illustrative diagram of a keypad with a sensing surface formed by placing a capacitive sensing unit beneath. When a finger presses a key, the mechanical pillar 320 of the key pushes down the elastic cap 340, which resists to the downward movement of the finger. The inner surface of elastic cap 340 is coated with electrically conductive material to form a conductive layer. When forced down by finger pressure, this conductive layer bends down and touches with the capacitive sensing unit beneath to make it switched ON. The microprocessor then determines the specific key being pressed and performs corresponding functions. If the finger pressure is reduced when the finger is released from the key, the elastic cap 340 pushes back the mechanical pillar 320 to return to its original position. This mechanism enables a tactile feedback and achieves the normal keypad behavior of a portable terminal.

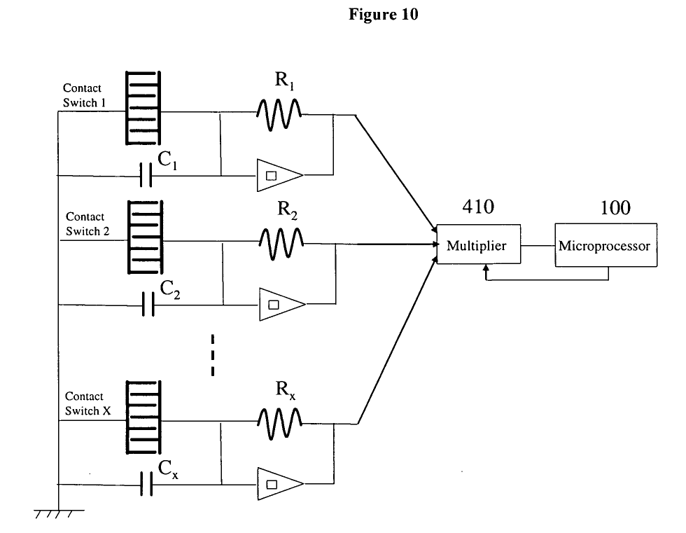

FIG. 10 is a portion of a schematic diagram of a circuit design in a preferred embodiment of the portable terminal of the present invention. The portion includes a sensing surface 150 formed by capacitive sensing units and a trajectory of movement coordinates data processor 160. It has one or more contact switches, resistors, capacitors, diodes, multipliers 400, and a microprocessor 100. Each contact switch 410 is connected to a resistor 420, a capacitor 430, and a diode 440 to form a capacitive sensing unit. This capacitive sensing unit is connected to the multiplier 400 and to the microprocessor 100. When a conductive finger moves on the keypad surface, the finger and the capacitor of the corresponding sensing unit generates changes in impedance, that enables the microprocessor 100 to identify and calculate multidimensional coordinates data (X, Y) of the finger. These components can be integrated in a single circuit.

The microprocessor with handwriting recognition software processes the multidimensional coordinates data (X, Y) and generates at least one candidate text of the desired text drawn with finger movement in the keypad area. It further display at least one of the candidate text on the screen of the portable terminal. A user can press some key or key combinations to select and confirm the desired text displayed on the screen of the portable terminal.

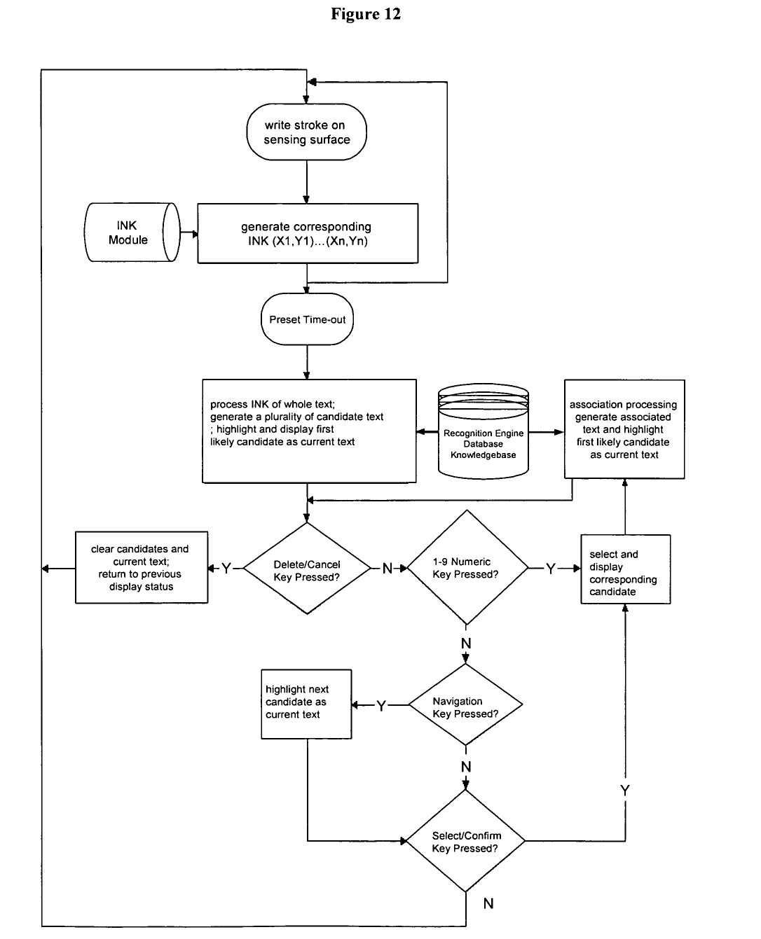

FIG. 12 is the flow chart of a text input procedure for entering text by writing the whole desired text.

When in text input mode, a user can use his finger to write the whole of a desired text on the sensing surface. The sensing unit generates multidimensional coordinates data (INK) from the trajectory of finger movement. After a preset time-out or similar end-of-writing signal, the microprocessor of the portable terminal processes the INK data using a combination of a recognition engine, a recognition database and a recognition knowledge base, generates a list of candidate text, and displays some of the candidates on the screen of the portable terminal.

Furthermore, the microprocessor highlights the first most likely candidate text as current text, which is displayed in the text editor area of the screen of the portable terminal.

The microprocessor of the portable terminal can further generate associated text based on the current text and the knowledge base. It can display one or more associated text in the association text display area on the screen of the portable terminal.

The user can then press one or more keys or key combinations to select and confirm the desired text from the list of candidate text.

In one example of the preferred embodiment of the present invention, each candidate text is shown on the screen of the portable terminal with a unique selection number corresponding to a specific digit key on the keypad. A user can press a digit key to select and confirm the corresponding candidate text, which will be displayed in the text editor area of the screen.

In another example of the preferred embodiment of the present invention, user presses navigation keys to move a cursor around, highlighting one candidate text. He then presses a confirm/select function key to select the highlighted candidate text and confirm it as the desired text to be displayed in the text editor area on the screen of the portable terminal. He can also press a delete/clear function key to delete/clear candidate text and/or highlighted current text and to return to previous state.

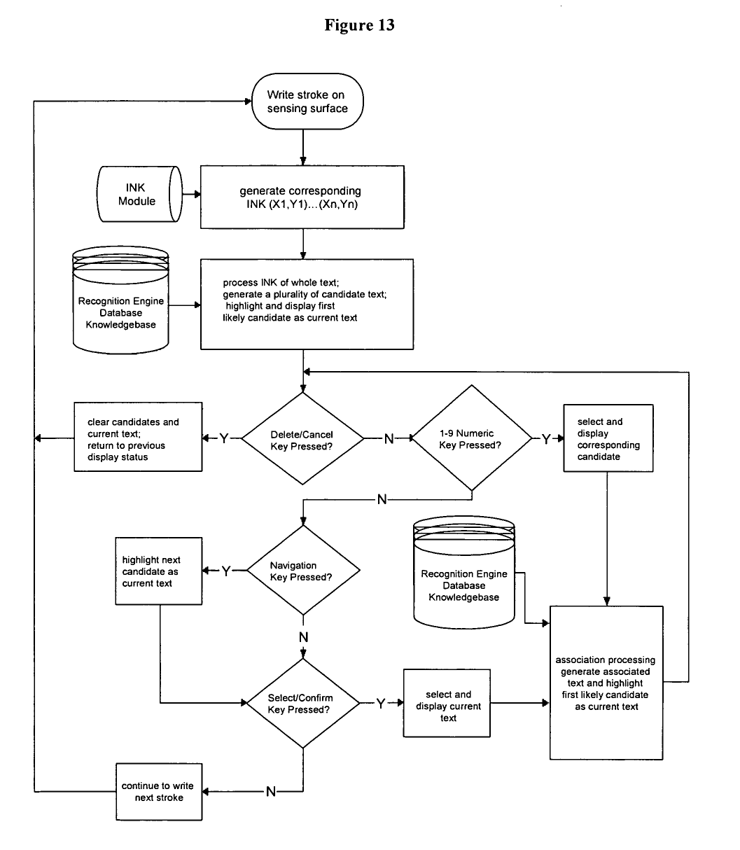

FIG. 13 shows the flow chart of an input procedure for entering text by writing desired text incrementally stroke by stroke.

When in text input mode, a user can use his finger to write partial strokes of a desired text on the sensing surface. The sensing unit generates multidimensional coordinates data (INK) from the trajectory of finger movement.

The microprocessor of the portable terminal processes the INK data of the stroke using a combination of a recognition engine, a recognition database, and a recognition knowledge base, generates a list of candidate text, and displays some of the candidate text on the screen of the portable terminal.

Furthermore, the microprocessor highlights the first most likely candidate text as current text, which is displayed in the text editor area of the screen of the portable terminal.

The microprocessor of the portable terminal can further generate associated text based on the current text and the knowledge base. It can display one or more associated text in the association text display area on the screen of the portable terminal.

The user can then press one or more keys or key combinations to select and confirm the desired text from the list of candidate text.

The detailed steps of desired text selection and confirmation can be the same as what in the previous embodiment described in the above paragraphs.

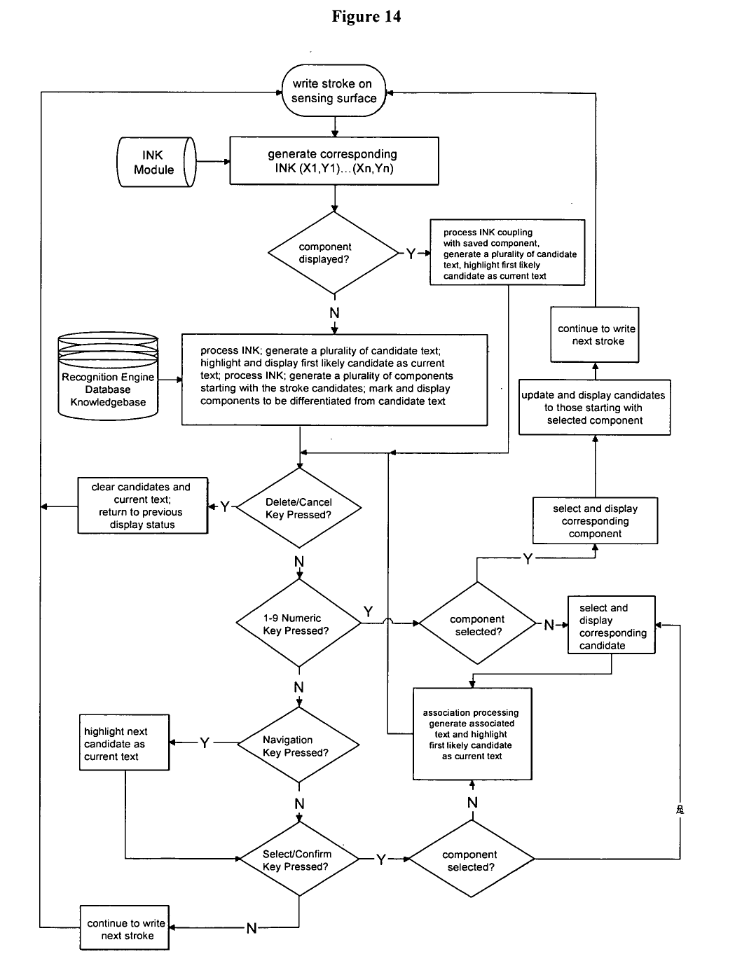

FIG. 14 shows the flow chart of an input procedure for entering text by writing desired text component by component.

When in text input mode, a user can also use his finger to first write the first component of the desired text on the sensing surface. The sensing unit generates multidimensional coordinates data (INK) from the trajectory of finger movement.

The microprocessor of the portable electronic appliance processes the INK data of the component using a combination of a recognition engine, a recognition database, and a recognition knowledge base, generates a list of candidate text and components of text which are best matching the user's writing, and displays some of the candidate text on the screen of the portable electronic appliance.

If the desired text is not in the list of candidates text, the user can press key or key combinations to select a corresponding text component matching his writing. The selection can be displayed on the screen of the portable electronic appliance.

After that, the microprocessor of the portable electronic appliance makes further processing based on the selected text component, and generates and displays a list of candidate text matching the selected text component.

If the desired text is still not in the newly generated list of candidate text, the user can use his finger to write on the sensing surface more strokes or components of the desired text.

The sensing unit generates multidimensional coordinates data (INK) from the trajectory of finger movement.

The microprocessor of the portable electronic appliance processes the INK data of the newly written stroke or component and the selected component using a combination of a recognition engine, a recognition database, and a recognition knowledge base, generates a list of candidate text and components of text which are best matching the user's current writing and the selected component, and displays some of the candidate text and/or components on the screen of the portable electronic appliance.

Repeating the above steps until the desired text is in the list of candidate text.

The user can then press one or more keys or key combinations to select and confirm the desired text from the list of candidate text.

The selected text can be displayed in the editor area on the screen of the portable electronic appliance.

The detailed steps of desired text selection and confirmation can be the same as what in the previous embodiment described in the above paragraphs.

The important benefits of the present invention are: it provides this new handwriting text input function while keeping the original physical size of the mobile handset and original functionality of the digit keypad of the mobile handset intact. In addition, it reduced the material cost of the mobile handset.

While embodiments and applications of this invention have been shown and described, it would be apparent to those skilled in the art that many more modifications and changes than mentioned above are possible without departing from the inventive concepts herein. This invention, therefore, is not to be restricted.

1. A method of handwriting text input on a portable terminal with a microprocessor, a screen, and a keypad area formed by at least one key, comprising of:
Placing at least one sensing unit in the keypad area of the portable terminal to form a sensing surface;
Writing, with a sensing object on the said sensing surface, at least partial information of a desired text, to form a trajectory of movement;
Generating, via the said sensing unit, multidimensional coordinates data from the said trajectory of movement of the said sensing object on the said sensing surface;
Generating, via the microprocessor of the portable terminal processing the said multidimensional coordinates data, at least one text candidate;
Displaying at least one of the said at least one text candidate on the screen of the portable terminal;
Selecting the said desired text from the said at least one text candidate by pressing at least one of the at least one key in the keypad area of the portable terminal;
Displaying the said desired text on the screen of the portable terminal.

2. A method of claim 1, wherein the said partial information of the said desired text can be any of a stroke, a component, a partial character, a character, a word, a sentence, or their combination.

3. A method of claim 2, wherein the said partial information written with the said sensing object on the said sensing surface can be stroke or stroke combination of the said desired text, the said at least one text candidate generated from the said processing of the said multidimensional coordinates data and displayed on the screen of the portable terminal can include text component such as radical, letter and affix, further comprises the steps of:
Selecting a text component from the said at least one text candidate by pressing at least one of the at least one key in the keypad area of the portable terminal;
Generating, via the microprocessor of the portable terminal, at least one associated text candidate corresponding to the said selected text component;
Displaying at least one of the at least one associated text candidate on the screen of the portable terminal, in place of the previous said at least one text candidate;
If the desired text is not in display, the method could further comprise the steps of:
Writing, with the said sensing object on the said sensing surface, at least one additional stroke or stroke combination of the desired text to form a new trajectory of movement, wherein the said additional stroke or stroke combination is not part of the said selected text component;
Generating, via the said sensing unit, multidimensional coordinates data of the said at least one additional stroke or stroke combination of the desired text from the said trajectory of movement of the said sensing object on the said sensing surface;
Generating, via the microprocessor of the said portable terminal processing the said multidimensional coordinates data and the said selected text component, at least one candidate text that may further include text component such as radical, letter and affix;
Displaying at least one of the said at least one candidate text on the screen of the portable terminal.
The above steps can be repetitively applied until the desired text is in display.

4. A method of claim 1, wherein the said sensing unit can be capacitive, generating multi-dimensional coordinates data through measuring the capacitance or the change of capacitance of the sensing unit; or resistive, generating multi-dimensional coordinates data through measuring the resistance or the change of resistance of the sensing unit: or inductive generating multi-dimensional coordinates data through measuring the inductance or the change of inductance of the sensing unit; or the combination of two or more of these types.

5. A method of claim 1, wherein the said at least one key can be: push-down button, roller button, gliding wheel, rotational switch, optical sensing switch, or bridge-sensing switch.

6. A method of claim 1, wherein the said at least one key is located on the outer surface of the portable terminal.

7. A method of claim 1, wherein the said sensing unit is coupled with the said at least one key in the said keypad area of the portable terminal.

8. A method of claim 7, wherein the said coupling of the said sensing unit and the said at least one key in the said keypad area of the portable terminal can be electronically combining and sharing electronic circuit of the said sensing unit and that of the said at least one key.

9. A method of claim 7, wherein the said coupling of the said sensing unit and the at least one key in the said keypad area of the portable terminal can be mechanically combining and sharing the mechanical structure of the said sensing unit and that of a plurality of the said at least one key.

10. A method of claim 1, wherein the said sensing object can be: human finger, input stylus or pen-shaped objects.

11. A method of claim 1, wherein the screen of the portable terminal has a text editor display area and a candidate text display area, further comprises the steps of:
Designating the most probable first candidate text as current text and displaying it in the text editor display area of the screen of the portable terminal;
Generating at least one associated candidate text of the said current text, wherein the generation is from the microprocessor of the portable terminal processing the knowledge of the said current text, wherein the said knowledge is retrieved from a knowledge base;
Displaying at least one associated candidate text in the candidate text display area of the screen of the portable terminal;
Selecting one of the said associated candidate text by pressing at least one key of the said at least one key, wherein the said associated candidate text can be character, word phrase, sentence or their combination;
Displaying the selected associated candidate text in the said text editor display area of the screen of the portable terminal.

12. A method of claim 1, wherein the said pressing of at least one key or key combination can be pressing numeric key; wherein the said selection of the desired text from the said candidate text can be to select the candidate text associated with a sequence number the same as the number marked on the said pressed numeric key, and wherein the said displaying of the selected text can be to display it in the text editor display area of the screen of the portable terminal.

13. A method of claim 1, wherein the selection of the desired text from the said candidate text by the said pressing of at least one key or key combination can be pressing at least one navigation functional key to move a cursor to a candidate text and pressing a confirm/select functional key to select this candidate text; and wherein the said displaying of the selected text can be to display it in the text editor display area of the screen of the portable terminal.

14. A method of claim 1, wherein the said generation of at least one candidate text of the desired text further comprises the step of pressing at least one of the said at least one key to delete at least one candidate text.

15. A method of claim 1, wherein the said generation of the at least one candidate text of the desired text, further comprises the step of pressing at least one of the said at least one key to change the order of the said at least one candidate text.

16. A method of claim 1, wherein the said generation of the at least one candidate text of the desired text, further comprises the step of pressing at least one of the said at least one key to insert at least one candidate text.

17. A method of claim 1, wherein the said sensing surface formed by printing the said sensing units on the surface area of the at least one key and the surface area between the said keys of the portable terminal.

18. A method of claim 1, wherein the said sensing unit is a contact switch.

19. A method of claim 17, wherein the said surface of the said at least one key can be the visible surface of the said key.

20. A method of claim 18, wherein the said contact switch is made of electrically conductive material and is connected to at least on resistor;
wherein the said sensing area is formed by arranging a plurality of the said contact switches as a matrix on the surface area of the said at least one key and the surface area between the said keys;
wherein each of the said contact switch is numbered and taken as a data sampling point;
wherein the said multi-dimensional coordinates data is generated by electronically coupling at least one of the said contact switches with a conductive sensing object electronically touching the said sensing surface;
wherein the said number of the at least one touched conduct switch is sent as coordinate data to the microprocessor of the portable terminal for processing;
wherein the said at least one key is triggered when the said conductive sensing object pressing the said key and causing electronic connection of the conductive switch;
wherein the microprocessor recognizes the pressed key and takes corresponding actions.

21. A method of claim 20, wherein the said contact switch is printed on the keypad area in shapes suitable for sensing.

22. A method of claim 20, wherein the said contact switch is printed on the keypad area in rectangular, circular, ovular, triangular, polygonal shape or other shapes suitable for sensing.

23. A method of claim 22, wherein contact switches of the same or different shapes are printed in the keypad area to form contact switch matrix.

24. A method of claim 32, wherein each sensing unit is a node of the said contact switch matrix.

25. A method of claim 22, wherein sensitivity of the sensing surface is dependent on the density of the said contact switch matrix.

26. A method of claim 1, wherein the said sensing units are placed under the surface of the said at least one key and under the surface area between the said keys of the portable terminal, to form sensing surface.

27. A method of claim 26, wherein the said sensing unit is made up of at least one contact switch made of electrically conductive materials, and each of the said contact switch is electronically connected to at least one resistor, at least one capacitance, and at least one diode to form a capacitive sensing component;
Wherein the said sensing surface is formed by at least one capacitive sensing unit placed as a matrix under the surface of the at least one key and the surface of the keypad area;
Wherein the said multidimensional coordinates data comes up when the said sensing object is placed on or near the said sensing surface in the keypad area to cause capacitive effects with the sensing units underneath, and when the said sensing object slides on the surface to form a trajectory of movement; the said multidimensional coordinates data is to be used by the microprocessor of the portable terminal for recognition process;
Wherein the said at least one key turns on when a finger-like object pushes the said key to cause a layer of conductive material inside the key to electronically connects the underneath contact switch; the microprocessor determines which key is pressed and carries corresponding functions.

28. A method of claim 1, wherein the said portable terminal is a mobile handset.

29. A method of claim 1, wherein the said keypad area can be the keypad area of a mobile handset.

30. A method of claim 1, wherein the said desired text can be in alphabetical letters, Chinese characters, Japanese characters, and other hieroglyphs and symbols.

31. A portable terminal with a keypad area formed by at least one key, further comprising:
A sensing surface, formed by at least one sensing unit placed in the keypad area of the portable terminal;
A sensing object, for writing at least partial information of a desired text on the said sensing surface, generating multidimensional coordinates data from the trajectory of the movement of the said sensing object via the said sensing unit;
A microprocessor, for processing the said multidimensional coordinates data and for generating at least one candidate text;
A screen, for displaying the said at least one candidate text;
The desired text can be selected from the said at least one candidate text by pressing the said at least one key, and be displayed on the said screen.

32. An apparatus of claim 31, wherein the said sensing unit can be capacitive, generating multi-dimensional coordinates data through measuring the capacitance or the change of capacitance of the sensing unit; or resistive, generating multi-dimensional coordinates data through measuring the resistance or the change of resistance of the sensing unit; or inductive generating multi-dimensional coordinates data through measuring the inductance or the change of inductance of the sensing unit; or the combination of two or more of these types.

33. An apparatus of claim 31, wherein the said at least one key can be: push-down button, roller button, gliding wheel, rotational switch, optical sensing switch, or bridge-sensing switch.

34. An apparatus of claim 31, wherein the said at least one key is located on the outer surface of the portable terminal.

35. An apparatus of claim 31, wherein the said sensing unit is coupled with the said at least one key in the said keypad area of the portable terminal.

36. An apparatus of claim 35, wherein the said coupling of the said sensing unit and the said at least one key in the said keypad area of the portable terminal can be electronically combining and sharing electronic circuit of the said sensing unit and that of the said at least one key.

37. An apparatus of claim 35, wherein the said coupling of the said sensing unit and the at least one key in the said keypad area of the portable terminal can be mechanically combining and sharing the mechanical structure of the said sensing unit and that of a plurality of the said at least one key.

38. An apparatus of claim 31, wherein the said sensing surface is formed by placing at least one sensing unit on the surface of the at least one key of the portable terminal and on the surface of the space between the said keys.

39. An apparatus of claim 38, wherein the said sensing unit is a contact switch.

40. An apparatus of claim 39, wherein the said sensing surface is formed by printing the said sensing units on the surface area of the at least one key and the surface area between the said keys of the portable terminal.

41. An apparatus of claim 38, wherein the said surface of the said at least one key can be the visible surface of the said key.

42. An apparatus of claim 40, wherein the said contact switch is made of electrically conductive material and is connected to at least on resistor;
wherein the said sensing area is formed by arranging a plurality of the said contact switches as a matrix on the surface area of the said at least one key and the surface area between the said keys;
wherein each of the said contact switch is numbered and taken as a data sampling point;
wherein the said multi-dimensional coordinates data is generated by electronically coupling at least one of the said contact switches with a conductive sensing object electronically touching the said sensing surface;
wherein the said number of the at least one touched conduct switch is sent as coordinate data to the microprocessor of the portable terminal for processing;
wherein the said at least one key is triggered when the said conductive sensing object pressing the said key and causing electronic connection of the conductive switch;
wherein the microprocessor recognizes the pressed key and takes corresponding actions.

43. An apparatus of claim 42, wherein the said contact switch is printed on the keypad area in shapes suitable for sensing.

44. An apparatus of claim 43, wherein the said contact switch is printed on the keypad area in rectangular, circular, ovular, triangular, polygonal shape or other shapes suitable for sensing.

45. An apparatus of claim 44, wherein contact switches of the same or different shapes are printed in the keypad area to form contact switch matrix.

46. An apparatus of claim 38, wherein each sensing unit is a node of the said contact switch matrix.

47. An apparatus of claim 38, wherein the sensitivity of the sensing surface is dependent on the density of the said contact switch matrix.

48. An apparatus of claim 31, wherein the said sensing units are placed under the surface of the said at least one key and under the surface area between the said keys of the portable terminal, to form sensing surface.

49. An apparatus of claim 48, wherein the said sensing unit is made up of at least one contact switch made of electrically conductive materials, and each of the said contact switch is electronically connected to at least one resistor, at least one capacitance, and at least one diode to form a capacitive sensing component;
Wherein the said sensing surface is formed by at least one capacitive sensing unit placed as a matrix under the surface of the at least one key and the surface of the keypad area;
Wherein the said multidimensional coordinates data comes up when the said sensing object is placed on or near the said sensing surface in the keypad area to cause capacitive effects with the sensing units underneath, and when the said sensing object slides on the surface to form a trajectory of movement; the said multidimensional coordinates data is to be used by the microprocessor of the portable terminal for recognition process;
Wherein the said at least one key turns on when a finger-like object pushes the said key to cause a layer of conductive material inside the key to electronically connects the underneath contact switch; the microprocessor determines which key is pressed and carries corresponding functions.

50. An apparatus of claim 31, wherein the said portable terminal is a mobile handset.

51. An apparatus of claim 31, wherein the said keypad area can be the keypad area of a mobile handset.
